(19) United States
(12) Patent Application Publication
(10) Pub. No.: US 2026/0159023 A1
(43) Pub. Date: Jun. 11, 2026

(54) COVER ATTACHMENT STRUCTURE AND OFF-ROAD VEHICLE

(71) Applicant: KAWASAKI MOTORS, LTD., Akashi-shi (JP)

(72) Inventors: Akihiro FUKUMOTO, Akashi-shi (JP); Takashi HISAMURA, Akashi-shi (JP)

(73) Assignee: KAWASAKI MOTORS, LTD., Akashi-shi (JP)

(21) Appl. No.: 19/409,876

(22) Filed: Dec. 5, 2025

(30) Foreign Application Priority Data
Dec. 11, 2024 (JP) 2024-216538

(51) Int. Cl. B60R 22/34; B60N 3/02; B60R 13/02

(52) U.S. Cl. CPC B60R 22/34; B60N 3/026; B60R 13/02; B60R 2022/3402

(57) ABSTRACT

A cover attachment structure includes: a hand bar located rearward of a seat and extending in vehicle width directions; a retractor that is attached to the hand bar and retracts a seatbelt; a cover covering the retractor at least from rear; and a bracket attached to the hand bar and fixing the cover at a position away from the hand bar in a direction orthogonal to a direction in which the hand bar extends.

### CROSS-REFERENCE TO RELATED APPLICATION

This application claims priority to Japanese Patent Application No. 2024-216538 filed on Dec. 11, 2024, the disclosure of which including the specification, the drawings, and the claims is hereby incorporated by reference in its entirety.

### FIELD

The technique disclosed here relates to a cover attachment structure and an off-road vehicle.

### BACKGROUND

U.S. Patent Application Publication No. 2017/0297627 discloses a vehicle including a retractor for front seats.

### BRIEF DESCRIPTION OF THE DRAWINGS

FIG. 1 is a left side view of a utility vehicle.

FIG. 2 is a side view of a body frame and seats when seen from the left.

FIG. 3 is a perspective view of the body frame and front seats when seen from the rear.

FIG. 4 is a perspective view of a left front seat when seen from the front.

FIG. 5 is a perspective view of a left cover attachment structure when seen from the rear.

FIG. 6 is a perspective view of the left cover attachment structure when seen from the front.

FIG. 7 is a perspective view illustrating a state where a left cover in FIG. 5 is detached.

FIG. 8 is a rear view of the left cover attachment structure when seen from the rear.

FIG. 9 is a cross-sectional view taken along line IX-IX in FIG. 8.

FIG. 10 is a perspective view of a cover attachment structure according to a first variation when seen from the rear.

FIG. 11 is a perspective view of a cover attachment structure according to a second variation when seen from the rear.

FIG. 12 is a perspective view of a cover attachment structure according to a third variation when seen from the rear.

FIG. 13 is a perspective view of a cover attachment structure according to a fourth variation when seen from the rear.

FIG. 14 is a perspective view of a cover attachment structure according to a fifth variation when seen from the rear.

### DESCRIPTION OF EMBODIMENTS

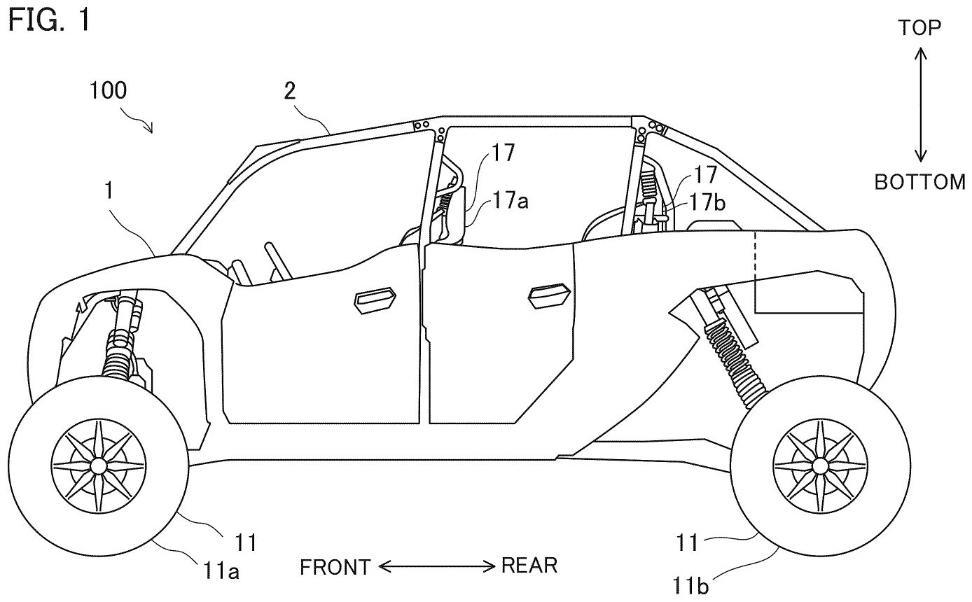

An exemplary embodiment will be described in detail hereinafter with reference to the drawings. FIG. 1 is a left side view of a utility vehicle 100. The utility vehicle 100 can travel off-road. The utility vehicle 100 is an example of an off-road vehicle. Hereinafter, the utility vehicle 100 will also be referred to simply as a “vehicle 100.” The utility vehicle includes a cargo bed and a roll over protective structure (ROPS) or low-pressure wheels, for example. The utility vehicle is, for example, a side-by-side vehicle.

In this disclosure, components of the vehicle 100 will be described based on directions of the vehicle 100. Specifically, “front” refers to the front in the front-rear directions of the vehicle 100, and “rear” refers to the rear in the front-rear directions of the vehicle 100. Further, “left” refers to the left of the vehicle 100 when seeing forward, and “right” refers to the right of the vehicle 100 when seeing forward. The “vehicle width directions” refer to the vehicle width directions of the vehicle 100, in other words, refers to the left-right directions of the vehicle 100 and will be sometimes referred to as “left-right directions.” An “inner side or inward in the vehicle width directions” refers to a cabin side in the vehicle width directions, and an “outer side or outward in the vehicle width directions” refers to a vehicle outer side in the vehicle width directions.

The vehicle 100 includes a body 1, a body frame 2, wheels 11, and seats 17 on which occupants are seated. The wheels 11 include left and right front wheels 11a and left and right rear wheels 11b. That is, the vehicle 100 is a four-wheeled vehicle. When the front wheels 11a and the rear wheels 11b are not distinguished from each other, these wheels are simply referred to as “wheels 11.”

The seats 17 include front seats 17a and rear seats 17b located rearward of the front seats 17a. In this example, the seats 17 include two front seats 17a arranged in the left-right directions, and two rear seats 17b arranged in the left-right directions. When the front seats 17a and the rear seats 17b are not distinguished from each other, these seats are simply referred to as “seats 17.”

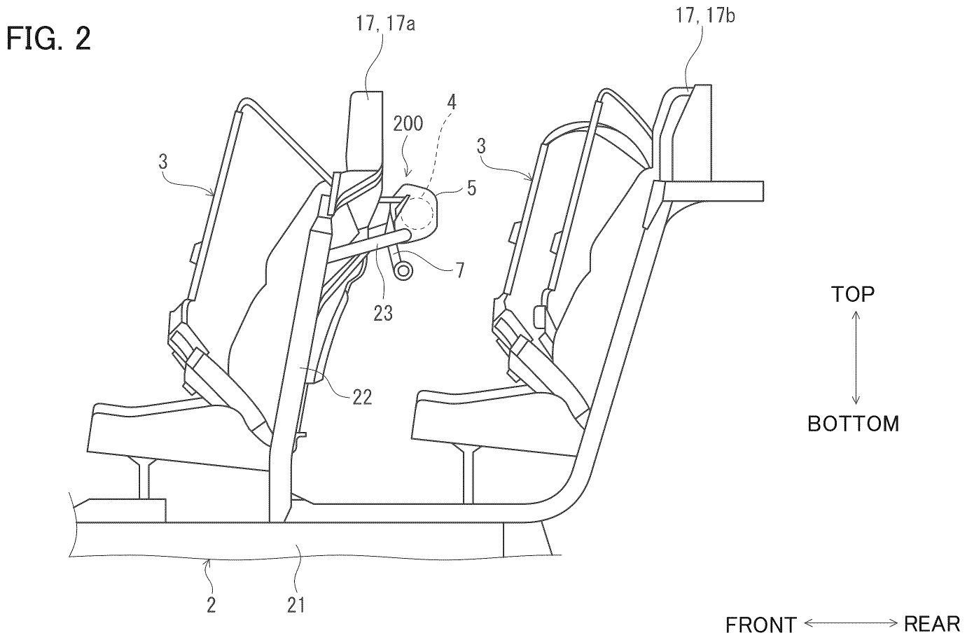

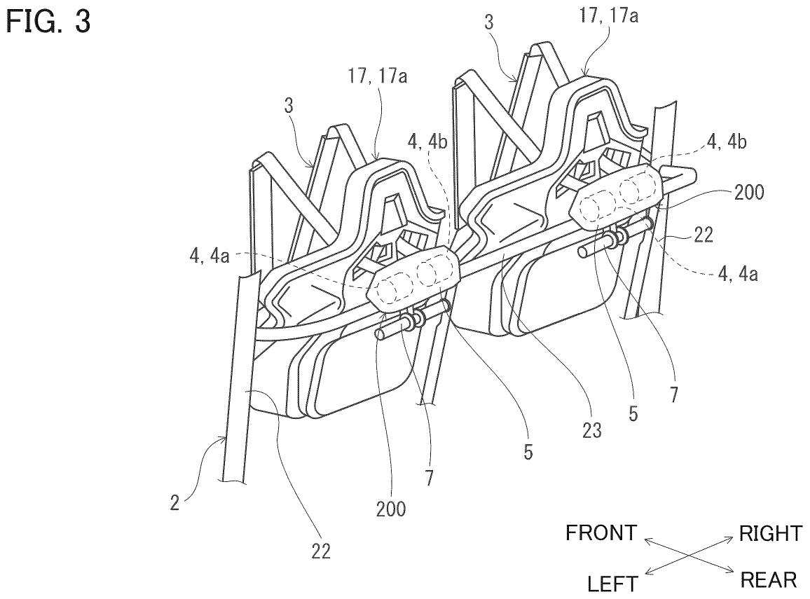

FIG. 2 is a side view of the body frame 2 and the seats 17 when seen from the left. FIG. 3 is a perspective view of the body frame 2 and the front seats 17a when seen from the rear.

The vehicle 100 further includes seatbelts 3, retractors 4, and covers 5. The seatbelts 3 are located at the seats 17 and restrain passengers in the seats 17. The retractors 4 retract the seatbelts 3 so that the seatbelts 3 can be pulled out. The covers 5 cover the retractors 4 at least from the rear. The body frame 2 includes a main frame 21, pillars 22, and a hand bar 23. The main frame 21 is located below the seats 17. The main frame 21 extends in the front-rear directions.

The pillars 22 are attached to the main frame 21. The pillars 22 extend in the top-bottom directions. The pillars 22 are located at the left and right sides. Specifically, the pillars 22 are located on both sides in the vehicle width directions with respect to the front seats 17a.

The hand bar 23 is attached to the pillars 22. Specifically, the hand bar 23 bridges across the left and right pillars 22 located forward of the rear seats 17b. The hand bar 23 extends in the vehicle width directions. The hand bar 23 is located rearward of the front seats 17a. The hand bar 23 is located above the seat surfaces of the seats 17. In this embodiment, the hand bar 23 is located at a position facing the shoulders of the seats 17. The shoulders of the seats 17 are located adjacent to and below the headrests of the seats 17 to support the shoulders of passengers from the rear. The hand bar 23 is located forward of the rear seats 17b so that passengers seated on the rear seats 17b can grip the hand bar 23.

The retractors 4 for the front seats are attached to the hand bar 23. The retractors for the front seats will be referred to simply as retractors 4. Each of the retractors 4 includes a take-up shaft that retracts the seatbelt 3 and a support structure that supports the winding shaft. The retractor 4 is attached to the hand bar 23 with the winding shaft extending in parallel with the vehicle width directions. Specifically, the retractor 4 is attached to an upper portion of the hand bar 23 with the winding shaft separated from the hand bar 23 in an upward direction. Each of the retractors 4 includes a first retractor 4a and a second retractor 4b arranged side by side in the vehicle width directions. The first retractor 4a is located at the left and the second retractor 4b is located at the right. The first retractor 4a and the second retractor 4b are located rearward of each of the left and right front seats 17a, respectively. When the first retractor 4a and the second retractor 4b are not distinguished from each other, these retractors are simply referred to as “retractors 4.”

The covers 5 are located rearward of the seatbacks of the left and right front seats 17a. The left cover 5 covers the left first retractor 4a and the left second retractor 4b at least from the rear. The right cover 5 covers the right first retractor 4a and the right second retractor 4b at least from the rear. Specifically, the covers 5 include portions covering rear surfaces of the retractors 4, portions covering side surfaces of the retractors 4 in the vehicle width directions, and portions covering upper surfaces of the retractors 4. The covers 5 prevent passengers from contacting the retractors 4.

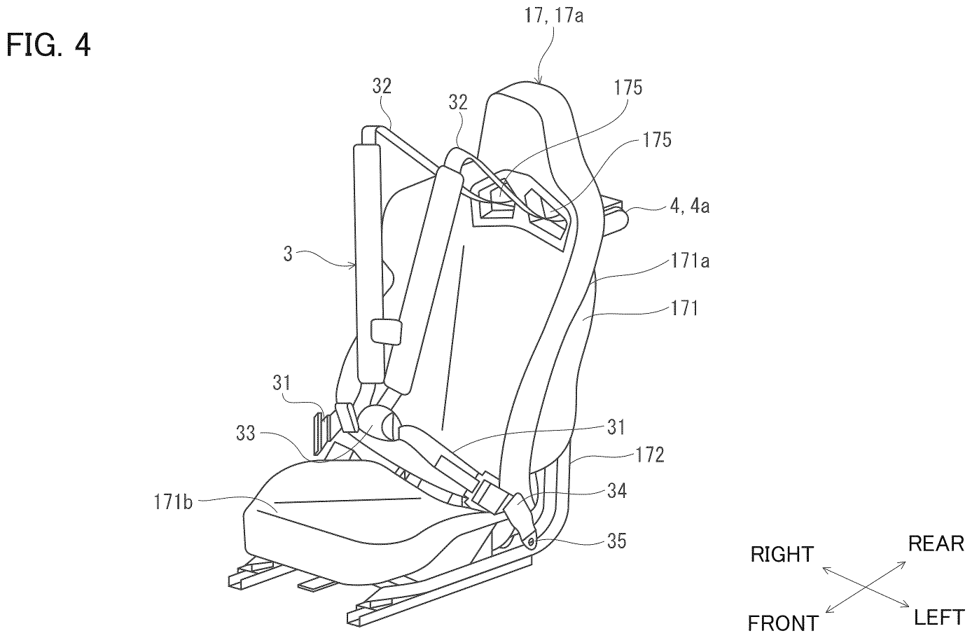

FIG. 4 is a perspective view of the left front seat 17a when seen from the front. The seat 17 includes a seat cushion 171 and a seat frame 172 supporting the seat cushion 171. The seat cushion 171 includes a back portion 171a that supports the back of the passenger, and a seat portion 171b that supports the buttocks of the passenger. The back portion 171a corresponds to a seatback for the passenger. The upper surface of the seat portion 171b corresponds to the seat surface. An upper portion of the back portion 171a includes two through holes 175 penetrating the back portion 171a in the front-rear directions. The two through holes 175 are located at the left and the right, respectively. A partition wall is located between the two through holes 175.

In this embodiment, the seatbelt 3 is a 4-point seatbelt. Specifically, the seatbelt 3 includes two side belts 31 corresponding to lateral abdominal regions of the passenger, two shoulder belts 32 corresponding to the shoulders of the passenger, and a buckle 33 that couples the side belts 31 and the shoulder belts 32. The buckle 33 includes a female portion that is connected to a first end of the left side belt 31 and a first end of the left shoulder belt 32, and a male portion that is connected to a first end of the right side belt 31 and a first end of the right shoulder belt 32. The male portion is inserted into the female portion and located therewith. The female portion includes a push button so that the male portion can be detached from the female portion by pushing the push button.

The side belts 31 are attached to the seat frame 172. Each of the side belts 31 includes a belt portion 34 and an attachment portion 35 that is attached to an end of the belt portion 34. The attachment portion 35 is, for example, a fixture. The attachment portion 35 is tied to the end of the belt portion 34. The attachment portion 35 is attached to the seat frame 172 with a screw.

Each of the shoulder belts 32 is inserted into the corresponding through hole 175 in an upper portion of the back portion 171a, and a second end of the shoulder belt 32 is connected to the corresponding retractor 4. The retractor 4 retracts the shoulder belt 32 such that the shoulder belt 32 can be pulled out. The retractor 4 fixes the shoulder belt 32 to prevent the shoulder belt 32 from being pulled out upon collision. The left shoulder belt 32 passes through the left through hole 175 to be connected to the first retractor 4a, and the right shoulder belt 32 passes through the right through hole 175 to be connected to the second retractor 4b. The first retractor 4a is located rearward of the left through hole 175 and faces the left through hole 175. The second retractor 4b is located rearward of the right through hole 175 and faces the right through hole 175.

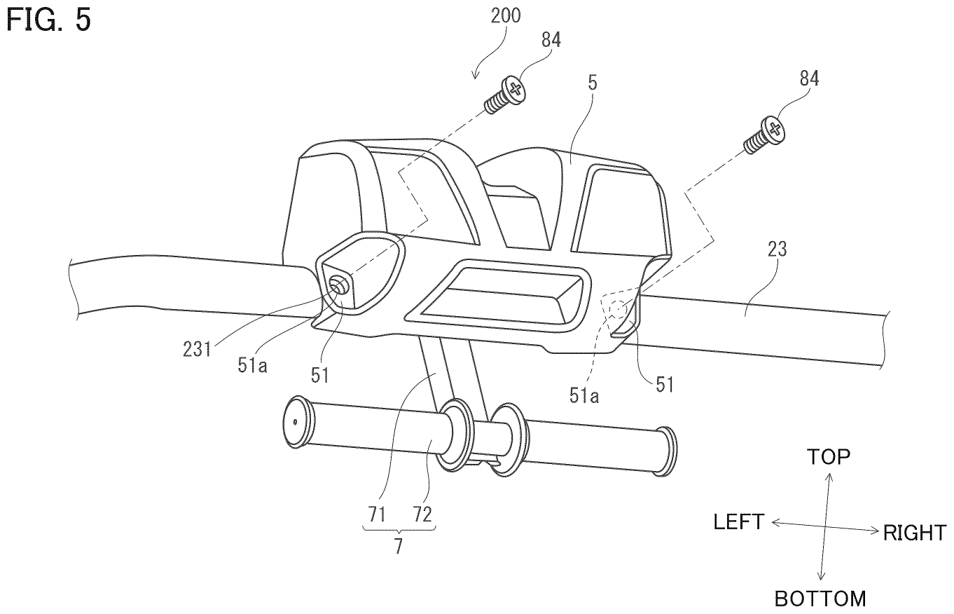

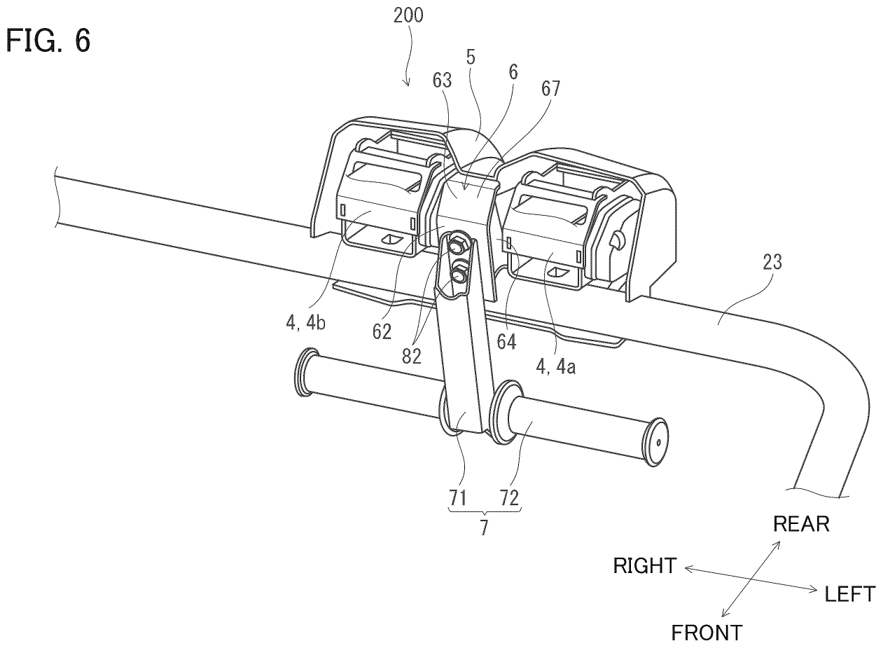

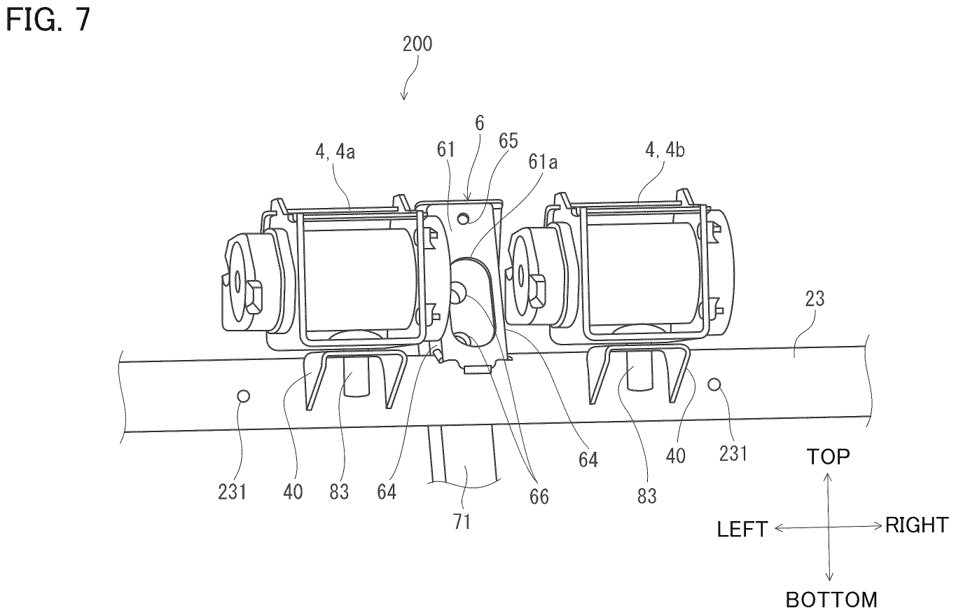

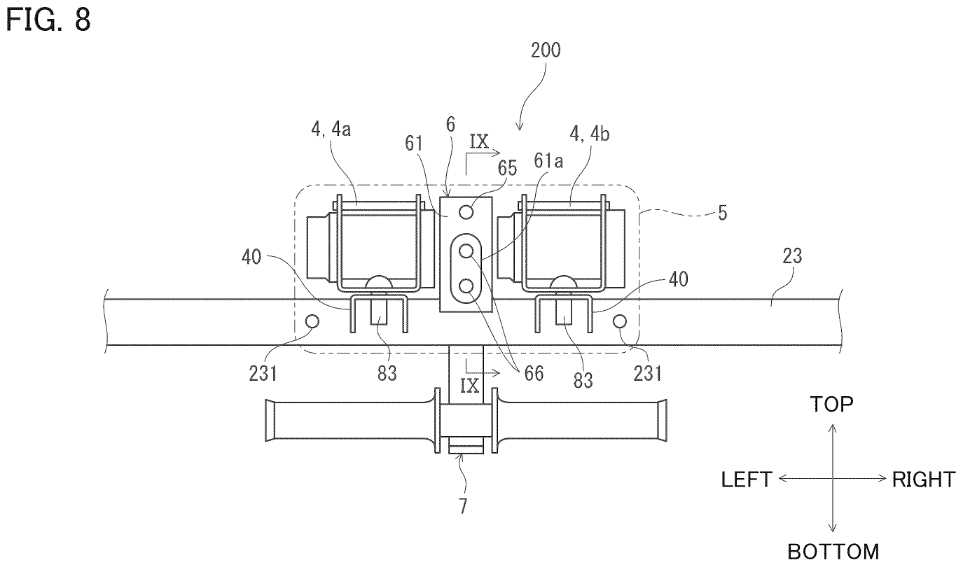

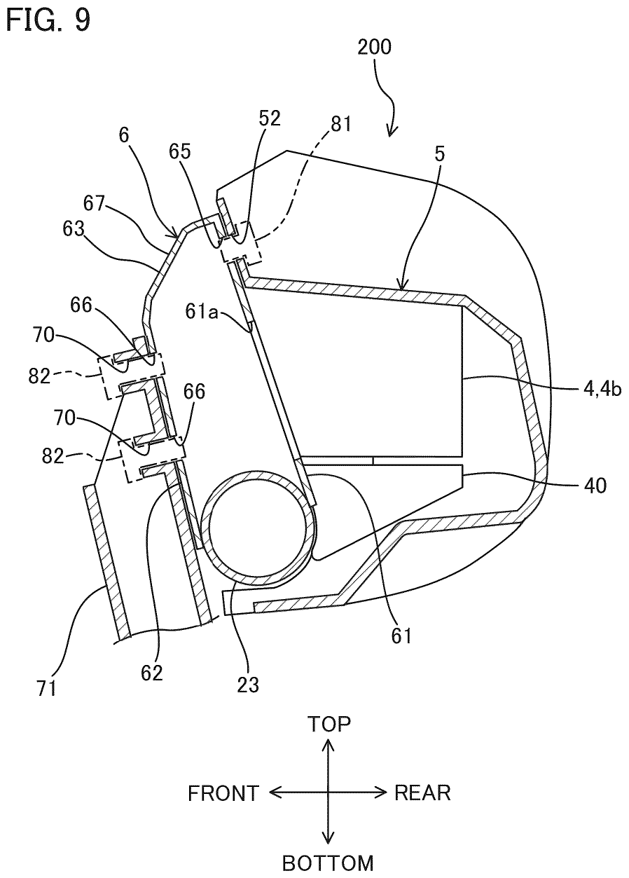

FIG. 5 is a perspective view of a left cover attachment structure 200 when seen from the rear. FIG. 6 is a perspective view of the left cover attachment structure 200 when seen from the front. FIG. 7 is a perspective view illustrating a state where the left cover 5 in FIG. 5 is detached. FIG. 8 is a rear view of the left cover attachment structure 200 when seen from the rear. FIG. 9 is a cross-sectional view taken along line IX-IX in FIG. 8.

The vehicle 100 includes a cover attachment structure 200. The cover attachment structure 200 is located at each of the left and the right. Although FIGS. 5 through 9 show the left cover attachment structure 200, the same holds for the right cover attachment structure 200.

Each cover attachment structure 200 includes the hand bar 23, the retractors 4, the cover 5, and the bracket 6. The cover attachment structure 200 further includes a grip 7.

The retractors 4 are supported by support plates 40. The support plates 40 are attached to the hand bar 23. The support plates 40 are fixed to the hand bar 23 by, for example, welding. The retractors 4 are attached to the support plates 40 via screws 83. The support plates 40 are attached to an upper portion of the hand bar 23. The support plates 40 are located on the hand bar 23 at the same positions as the through holes 175 of the seats 17 in the vehicle width directions. The support plates 40 of the left and right retractors 4 are spaced apart from each other in the vehicle width directions.

The bracket 6 is attached to the hand bar 23. The bracket 6 is fixed to the hand bar 23 by, for example, welding. The bracket 6 is located between the first retractor 4a and the second retractor 4b. The bracket 6 extends upward from the hand bar 23.

The bracket 6 fixes the cover 5 at a position away from the hand bar 23 in a direction orthogonal to the direction in which the hand bar 23 extends. In other words, the bracket 6 fixes the cover 5 at a position away from the hand bar 23 in the radial direction of the hand bar 23. Specifically, the bracket 6 fixes the cover 5 at a position separated from the hand bar 23 in an upward direction.

The bracket 6 includes a bracket-side fixing portion 65, accessory attachment portions 66, and a stopper portion 67. The bracket-side fixing portion 65 fixes the cover 5 at a side opposite to the hand bar 23 with respect to the center of the retractor 4. The center of the retractor 4 is located between the bracket-side fixing portion 65 and the hand bar 23. The center of the retractor 4 is a point at which the center planes of the retractor 4 in the three-dimensional directions intersect. The bracket-side fixing portion 65 is a hole into which the screw 81 (see FIG. 9) is inserted. The screw 81 is inserted into the bracket-side fixing portion 65 through the cover 5 and fixes the cover 5 to the bracket-side fixing portion 65. In FIG. 9, the screw 81 is indicated by the chain double-dashed line. The bracket-side fixing portion 65 may be a projection, and the projection may be locked with a hole in the cover 5.

The accessory attachment portion 66 allows attachment of an accessory different from the cover 5. In this example, the accessory is the grip 7, and the accessory may be, for example, a baggage component, a cup holder, a smartphone holder, or a tablet holder. The accessory attachment portions 66 are holes in which the screws 82 (see FIG. 9) are inserted. The screws 82 are inserted into the accessory attachment portions 66 through the accessory and fix the accessory to the accessory attachment portions 66. In FIG. 7, the screws 82 are omitted, and in FIG. 9, the screws 82 are indicated by chain double-dashed lines. The accessory attachment portions 66 may be projections, and the projections may be locked with holes in the accessory.

The stopper portion 67 is in contact with the seat 17 to restrict rearward movement of the seat 17. Specifically, the stopper portion 67 faces the rear surface of the front seat 17a. The stopper portion 67 is in contact with the rear surface of the front seat 17a to restrict rearward movement of the front seat 17a.

The bracket 6 includes a first plate 61, a second plate 62, a third plate 63, and a fourth plate 64. The first plate 61 expands upward from the hand bar 23. The second plate 62 is located forward of the first plate 61 with a space therebetween and expands upward from the hand bar 23. The third plate 63 is located above the first plate 61 and the second plate 62 and coupled to the first plate 61 and the second plate 62. The third plate 63 is oriented forward and upward. The fourth plates 64 are located at the left and the right and coupled to the first plate 61 and the second plate 62.

The bracket-side fixing portion 65 is located in the first plate 61. The accessory attachment portions 66 are located in the second plate 62. The stopper portion 67 is located on the third plate 63. The first plate 61 has a through hole 61a at a position facing the accessory attachment portions 66. The accessory attachment portions 66 are exposed through the through hole 61a. An operator is allowed to reach the accessory attachment portions 66 through the through hole 61a.

The hand bar 23 includes bar-side fixing portions 231. The bar-side fixing portions 231 fix the cover 5 at a side opposite to the bracket-side fixing portion 65 with respect to the center of the retractor 4. The center of the retractor 4 is located between the bracket-side fixing portion 65 and the bar-side fixing portions 231. The bar-side fixing portions 231 fix the cover 5 to the bracket-side fixing portion 65 at positions that are spaced apart from each other in the vehicle width directions. Specifically, the bar-side fixing portions 231 fix the cover 5 to the first retractor 4a and the second retractor 4b at positions spaced apart from each other in the vehicle width directions.

The bar-side fixing portions 231 are holes into which screws are inserted. The screws are inserted into the bar-side fixing portions 231 through the cover 5 to fix the cover 5 to the bar-side fixing portions 231. The bar-side fixing portions 231 may be projections, and the projections may be locked with holes in the cover 5.

The cover 5 includes contact portions 51 that are brought into contact with the hand bar 23 from the rear. The contact portions 51 are located at the left and the right of the cover 5. The contact portions 51 include holes 51a. The contact portions 51 face the bar-side fixing portions 231. Specifically, the holes 51a overlap the bar-side fixing portions 231. Screws 84 are inserted into the holes 51a and the bar-side fixing portions 231 so that the cover 5 can be fixed to the hand bar 23 via the screws 84. The hand bar 23 may include nuts that allow the screws 84 to be coupled to the hand bar 23. The cover 5 includes a cover-side fixing portion 52 that is fixed to the bracket 6. The cover-side fixing portion 52 faces the bracket-side fixing portion 65. The cover-side fixing portion 52 is a hole into which the screw 81 is inserted. The screw 81 is inserted into the cover-side fixing portion 52 and the bracket-side fixing portion 65 so that the cover 5 can be fixed to the bracket 6 via the screw 81. The cover-side fixing portion 52 may be a projection, and the projection may be locked with the bracket-side fixing portion 65.

In this manner, the cover 5 is fixed to the hand bar 23 at two positions that are the ends in the vehicle width directions, and is fixed at one position above the hand bar 23 in the bracket 6. That is, the cover 5 is fixed at three points corresponding to the vertices of a triangle. Since the cover 5 is supported by the hand bar 23 and the bracket 6 located forward of the cover 5, the cover 5 is prevented from being displaced or deformed even under a load from the rear.

The cover 5 covers the retractors 4 from the rear and leaves the retractors 4 exposed at front. Specifically, the cover 5 is a bowl-shaped cover that is open at the front. The front surfaces of the retractors 4 are exposed to the front through the openings of the cover 5 at the front. The portions of the cover 5 are openings of the cover 5. The openings of the cover 5 include a first opening that covers the first retractor 4a and a second opening that covers the second retractor 4b. In other words, the cover 5 includes at least openings through which the seatbelts 3 are inserted and removed from the retractors 4.

The cover 5 covers at least a portion of the bracket 6. Specifically, the cover 5 covers the rear surface of the bracket 6. More specifically, the cover 5 covers the rear surface of the first plate 61 of the bracket 6.

The cover 5 leaves a periphery of the bracket 6 exposed. The periphery of the bracket 6 is a region around the bracket 6 in the front-rear directions. Specifically, the cover 5 leaves the front surface, the left and right side surfaces, and the upper surface of the bracket 6 exposed. More specifically, the cover 5 leaves the second plate 62, the third plate 63, and the left and right fourth plates 64 of the bracket 6 exposed.

The grip 7 is located rearward of the seats 17, specifically, the front seats 17a. The grip 7 is located forward of the rear seats 17b so that a passenger seated on the rear seat 17b can grip the grip 7.

The grip 7 is attached to the bracket 6. Specifically, the grip 7 includes grip-side attachment portions 70 fixed to the bracket 6. The grip-side attachment portions 70 face the accessory attachment portions 66. The grip-side attachment portions 70 are holes into which the screws 82 are inserted. The screws 82 are inserted into the grip-side attachment portions 70 and the accessory attachment portions 66, and the grip 7 is fixed to the bracket 6 via the screws 82. The grip-side attachment portions 70 may be projections, and the projections may be locked with the accessory attachment portions 66.

The grip 7 includes a vertical portion 71 extending in the top-bottom directions, and a horizontal portion 72 extending in the vehicle width directions. A first end of the vertical portion 71 is attached to the accessory attachment portions 66 of the bracket 6. That is, the grip-side attachment portions 70 are located on the vertical portion 71. A second end of the vertical portion 71 is attached to an intermediate portion of the vertical portion 71. In this manner, the grip 7 has a T shape.

The first end of the vertical portion 71 is above the second end of the vertical portion 71. The horizontal portion 72 is located below the hand bar 23.

A grip portion of the grip 7 is located at a position different from a position of the hand bar 23 in the top-bottom directions. Specifically, left and right end portions of the horizontal portion 72 are the grip portions of the grip 7. The grip portions of the grip 7 are located below the hand bar 23.

The first end of the vertical portion 71 may be located below the second end of the vertical portion 71. That is, the horizontal portion 72 may be located above the hand bar 23, and the grip portions of the grip 7 may be located above the hand bar 23.

In the cover attachment structure 200 and the vehicle 100 described above, the cover 5 is fixed to the bracket 6 at a position away from the hand bar 23 in the direction orthogonal to the direction in which the hand bar 23 extends. Thus, deformation of the cover 5 can be prevented at a position away from the hand bar 23. For example, even when a passenger comes into contact with the cover 5, deformation of the cover 5 can be prevented.

Since the retractors 4 and the bracket 6 are attached to the hand bar 23, the retractors 4 are indirectly connected to the bracket 6. Accordingly, in a case where the cover 5 is attached to the bracket 6 and when a passenger comes into contact with the cover 5 to exert an external force to the cover 5, the external force is transmitted to the bracket 6 but is prevented from being transmitted to the retractors 4. Consequently, even when an external force is applied to the cover 5, the retractors 4 are less likely to be affected by the external force.

The bracket-side fixing portion 65 of the bracket 6 fixes the cover 5 at the side opposite to the hand bar 23 with respect to the center of the retractors 4. Thus, the cover 5 can be fixed at a position away from the hand bar 23 while covering the retractors 4, thus further preventing deformation of the cover 5.

Since the contact portions 51 of the cover 5 contact the hand bar 23 from the rear, when the rear surface of the cover 5 is pushed forward, the contact portions 51 of the cover 5 come into contact with the hand bar 23 so that the cover 5 can be supported by the hand bar 23.

Further, the bar-side fixing portions 231 of the hand bar 23 fix the cover 5 at the side opposite to the bracket-side fixing portion 65 with respect to the center of the retractors 4. Thus, the presence of the retractors 4 between the bar-side fixing portions 231 and the bracket-side fixing portion 65 easily prevents deformation of the cover 5.

The bar-side fixing portions 231 of the hand bar 23 fix the cover 5 to the bracket-side fixing portion 65 at positions that are spaced apart from each other in the vehicle width directions. Thus, the cover 5 is fixed by the bracket-side fixing portion 65 of the bracket 6 and the two bar-side fixing portions 231 of the hand bar 23 so that deformation of the cover 5 can be easily prevented.

Since the bracket 6 is located between the first retractor 4a and the second retractor 4b, the both sides of the bracket 6 are covered with the first retractor 4a and the second retractor 4b, thereby reducing exposure of the bracket 6.

The bar-side fixing portions 231 of the hand bar 23 fix the cover 5 to the first retractor 4a and the second retractor 4b at end positions that are spaced apart from each other in the vehicle width directions. Thus, the cover 5 is fixed by the two bar-side fixing portions 231 of the hand bar 23 so that deformation of the cover 5 can be easily prevented.

Since the cover 5 covers at least a portion of the bracket 6, the cover 5 serves as both a component covering the retractors 4 and a component covering the bracket 6.

Since the front surfaces of the retractors 4 are exposed to the front through the portions of the cover 5 where the cover 5 is open at the front, interference between the seats 17 and the cover 5 can be prevented. For example, the retractors 4 and the hand bar 23 can be located close to the seats 17. In a case where the seats 17 are slidable in the front-rear directions, the amount of rearward sliding of the seats 17 can be easily increased.

Since the cover 5 leaves the periphery of the bracket 6 exposed, another member such as an accessory is easily attached to the bracket 6 through a region where the bracket 6 is exposed, in the state where the cover 5 is attached.

Since the bracket 6 includes the stopper portion 67, rearward movement of the seat 17 can be restricted. For example, in a case where the seat 17 can be reclined in the front-rear directions, the stopper portion 67 can restrict rearward reclining of the seat 17. Alternatively, in a case where an excessive pressing force in a rearward tilting direction is applied to the seat 17, the stopper portion 67 can restrict rearward tilting of the seat 17 before the seat 17 is damaged by the pressing force. Alternatively, in a case where the seat 17 is slidable in the front-rear directions, the stopper portion 67 can restrict rearward sliding of the seat 17.

Since the bracket 6 includes the accessory attachment portions 66, an accessory can be attached to the bracket 6.

Since the grip 7 is attached to the bracket 6, the bracket 6 enables attachment of the grip 7 as well as the cover 5, and the bracket 6 serves as both a component supporting the cover 5 and a component supporting the grip 7.

Since the grip 7 is attached to the bracket 6, in a case where two passengers are seated behind the hand bar 23 and the grip 7, one passenger can grip the grip 7 and the other passenger can grip the hand bar 23.

Since the grip 7 has the T shape, the passenger can grip the horizontal portion of the grip 7.

The position of the grip portion of the grip 7 is different from the position of the hand bar 23 in the top-bottom directions. Thus, in a case where one passenger grips the grip portion of the grip 7 and another passenger grips the hand bar 23, the height positions of the arms of the two passengers are different. This reduces interference between the arms of the two passengers.

### «First Variation»

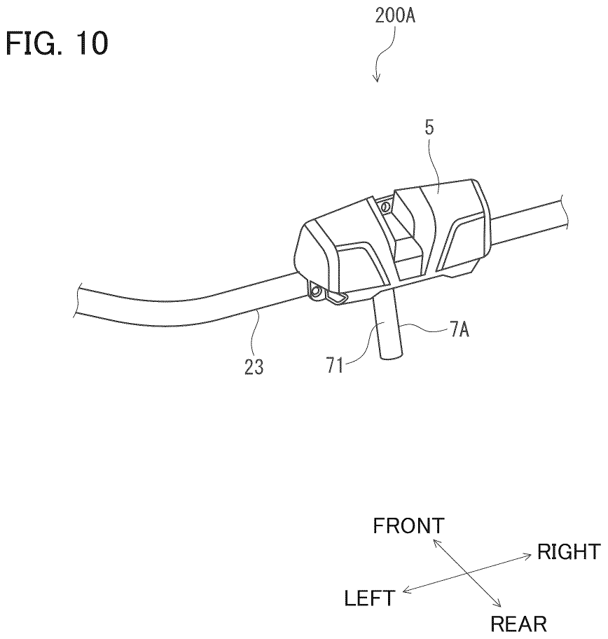

FIG. 10 is a perspective view of a cover attachment structure 200A according to a first variation when seen from the rear. Although FIG. 10 shows the left cover attachment structure 200A, the same holds for a right cover attachment structure 200A.

The cover attachment structure 200A according to the first variation is different from the cover attachment structure 200 according to the embodiment in a grip 7A. In the first variation, the same reference characters as those in the embodiment denote the same components, and thus, description thereof will be omitted.

In the cover attachment structure 200A according to the first variation, the grip 7A includes a vertical portion 71 extending in the top-bottom directions. A first end of the vertical portion 71 is attached to accessory attachment portion 66 (see FIG. 9) of a bracket 6. In this manner, the grip 7A has an I shape.

The first end of the vertical portion 71 is located above a second end of the vertical portion 71. The second end of the vertical portion 71 is a grip portion of the grip 7A. The grip portion of the grip 7A is located below the hand bar 23.

The first end of the vertical portion 71 may be located below the second end of the vertical portion 71. That is, the grip portion of the grip 7A may be located above the hand bar 23.

In the thus-configured cover attachment structure 200A, since the grip 7A has the I shape, a passenger can grip the vertical portion of the grip 7A.

The description of other configurations, operations, and effects will be omitted, but the description of the cover attachment structure 200 according to the embodiment can be used for the description of the cover attachment structure 200A according to the first variation.

### «Second Variation»

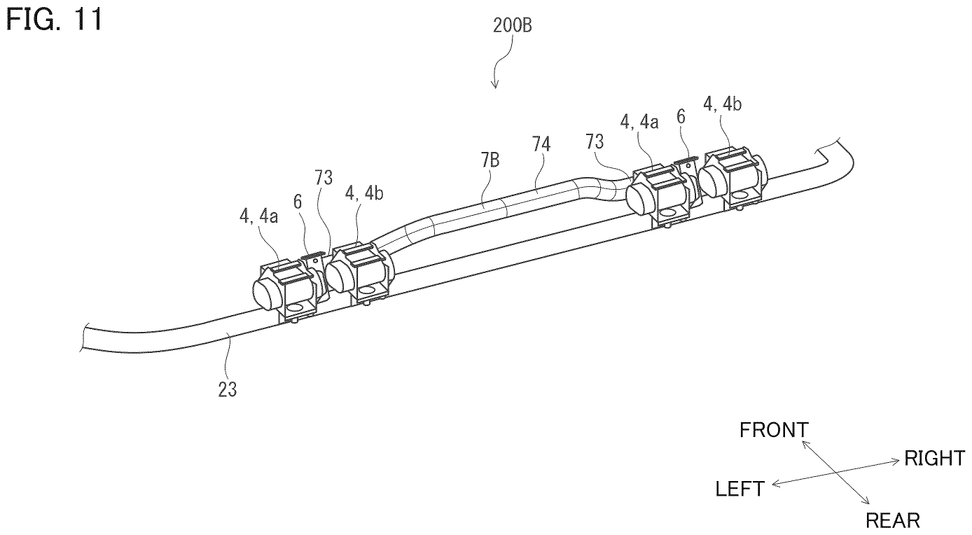

FIG. 11 is a perspective view of a cover attachment structure 200B according to a second variation when seen from the rear. In FIG. 11, the cover 5 is omitted. The cover attachment structure 200B according to the second variation is different from the cover attachment structure 200 according to the embodiment in a grip 7B and other components. In the second variation, the same reference characters as those in the embodiment denote the same components, and thus, description thereof will be omitted.

The cover attachment structure 200B according to the second variation includes left and right brackets 6 arranged side by side in the vehicle width directions, and the grip 7B extending in the vehicle width directions and bridging across the left and right brackets 6. The grip 7B bridges across accessory attachment portions 66 (see FIG. 9) of the left and right brackets 6.

The grip 7B includes end portions 73 located at both ends in the vehicle width directions and extending in the vehicle width directions, and an intermediate portion 74 located between the end portions 73 at both ends and extending in the vehicle width directions. The left end portion 73 is fixed to the accessory attachment portion 66 of the left bracket 6. The right end portion 73 is fixed to the accessory attachment portion 66 of the right bracket 6. The intermediate portion 74 is located above the end portions 73 in the top-bottom directions. The grip 7B is located above the hand bar 23.

In the thus-configured cover attachment structure 200B, since the grip 7B bridges across the left and right brackets 6, a sufficient length of the grip 7B in the vehicle width directions can be obtained. Accordingly, in a case where a passenger is seated behind the grip 7B, the range in which the passenger can grip the grip 7B can be enlarged.

Since the intermediate portion 74 of the grip 7B is located above the end portions 73 of the grip 7B in the top-bottom directions, in a case where one passenger grips the intermediate portion 74 and another passenger grips the end portions 73, the height positions of the arms of the two passengers are different. This reduces interference between the arms of the two passengers.

Since the grip 7B is located above the hand bar 23, in a case where one passenger grips the grip portions of the grip 7B and another passenger grips the hand bar 23, the height positions of the arms of the two passengers are different. This reduces interference between the arms of the two passengers.

The description of other configurations, operations, and effects will be omitted, but the description of the cover attachment structure 200 according to the embodiment can be used for the description of the cover attachment structure 200B according to the second variation.

### «Third Variation»

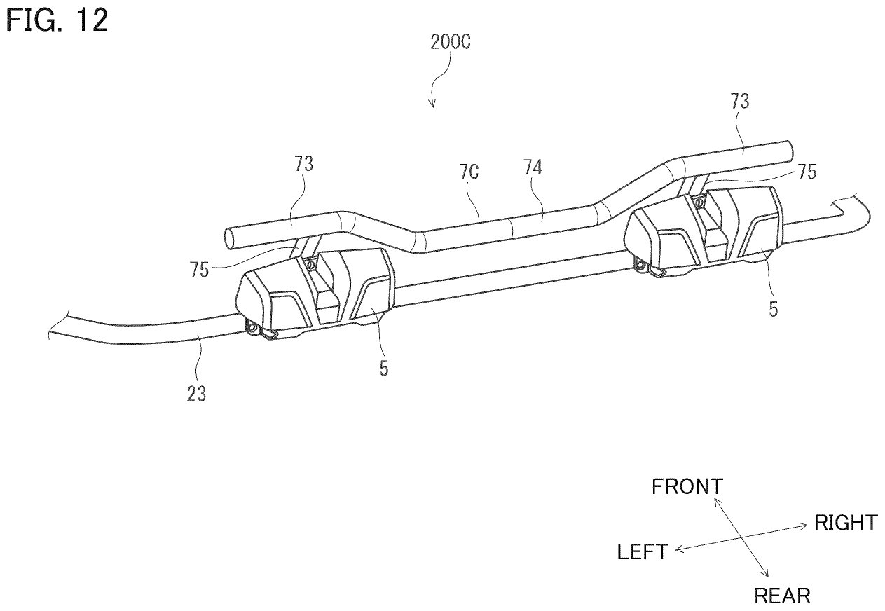

FIG. 12 is a perspective view of a cover attachment structure 200C according to a third variation when seen from the rear. The cover attachment structure 200C according to the third variation is different from the cover attachment structure 200B according to the second variation in a grip 7C. In the third variation, the same reference characters as those in the second variation denote the same components, and thus, description thereof will be omitted.

In the cover attachment structure 200C according to the third variation, the grip 7C includes end portions 73 located at both ends in the vehicle width directions and extending in the vehicle width directions, and an intermediate portion 74 located between the end portions 73 at both ends and extending in the vehicle width directions. The grip 7C further includes attachment portions 75 extending downward from the end portions 73. The attachment portions 75 are fixed to accessory attachment portions 66 (see FIG. 9) of the bracket 6.

The intermediate portion 74 is located below the end portions 73 in the top-bottom directions. The grip 7C is located above the hand bar 23.

In the thus-configured cover attachment structure 200C, since the intermediate portion 74 of the grip 7C is located below the end portions 73 of the grip 7C in the top-bottom directions, in a case where one passenger grips the intermediate portion 74 and another passenger grips the end portions 73, the height positions of the arms of the two passengers are different. This reduces interference between the arms of the two passengers.

The description of other configurations, operations, and effects will be omitted, but the description of the cover attachment structure 200B according to the second variation can be used for the description of the cover attachment structure 200C according to the third variation.

### «Fourth Variation»

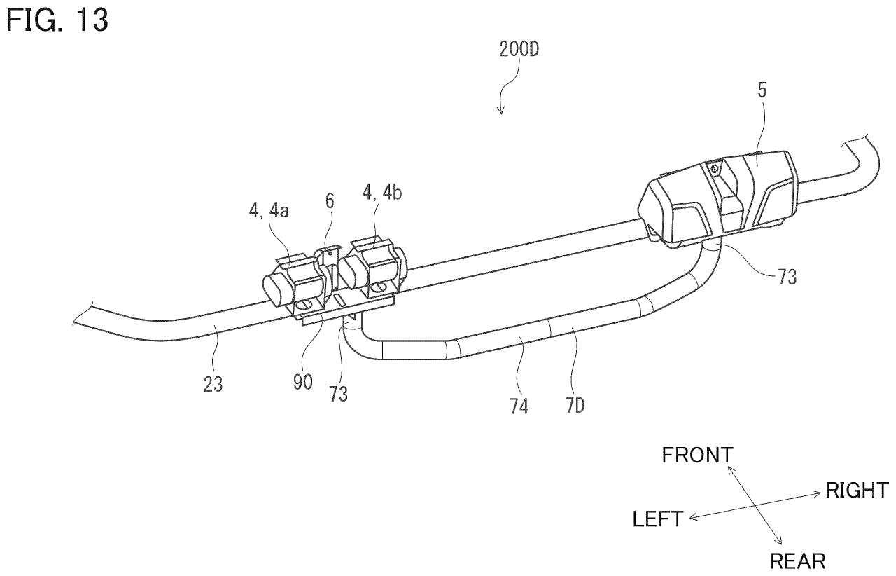

FIG. 13 is a perspective view of a cover attachment structure 200D according to a fourth variation when seen from the rear. In FIG. 13, the left cover 5 is omitted. The cover attachment structure 200D according to the fourth variation is different from the cover attachment structure 200 according to the embodiment in a grip 7D and other components. In the fourth variation, the same reference characters as those in the embodiment denote the same components, and thus, description thereof will be omitted.

The cover attachment structure 200D according to the fourth variation includes left and right brackets 6 arranged side by side in the vehicle width directions, left and right attachment plates 90 arranged side by side in the vehicle width directions, and the grip 7D extends in the vehicle width directions and bridges across the left and right attachment plates 90. The right attachment plate 90 is covered by the cover 5, and the same holds for the left attachment plate 90.

The attachment plates 90 are attached to a hand bar 23. The attachment plates 90 are fixed to the hand bar 23 by, for example, welding. The attachment plates 90 support the retractors 4. Specifically, the first retractor 4a and the second retractor 4b are attached to the attachment plates 90 via screws.

The grip 7D includes end portions 73 located at both ends in the vehicle width directions and extending downward, and an intermediate portion 74 located between the end portions 73 at both ends and extending in the vehicle width directions. The left end portion 73 is fixed to the left attachment plate 90. The right end portion 73 is fixed to the right attachment plate 90. The intermediate portion 74 is located rearward of the end portions 73 in the front-rear directions. The intermediate portion 74 is located rearward of the hand bar 23 in the front-rear directions. The grip 7D is located below the hand bar 23.

In the thus-configured cover attachment structure 200D, since the grip 7D bridges across the left and right attachment plates 90, a sufficient length of the grip 7D in the vehicle width directions can be obtained. Accordingly, in a case where a passenger is seated behind the grip 7D, the range in which the passenger can grip the grip 7D can be enlarged.

Further, since the attachment plates 90 support the retractors 4, the attachment plates 90 serve as components supporting the retractors 4 and components supporting the grip 7D.

Since the intermediate portion 74 is located rearward of the end portions 73 in the front-rear directions, in a case where one passenger grips the intermediate portion 74 and another passenger grips the end portions 73, the positions of the arms of the two passengers are different in the front-rear directions. This reduces interference between the arms of the two passengers.

Since the intermediate portion 74 is located rearward of the hand bar 23, in a case where one passenger grips the intermediate portion 74 and another passenger grips the hand bar 23, the positions of the arms of the two passengers are different in the front-rear directions. This reduces interference between the arms of the two passengers.

Since the grip 7D is located below the hand bar 23, in a case where one passenger grips the grip 7D and another passenger grips the hand bar 23, the height positions of the arms of the two passengers are different. This reduces interference between the arms of the two passengers.

The description of other configurations, operations, and effects will be omitted, but the description of the cover attachment structure 200 according to the embodiment can be used for the description of the cover attachment structure 200D according to the fourth variation.

### «Fifth Variation»

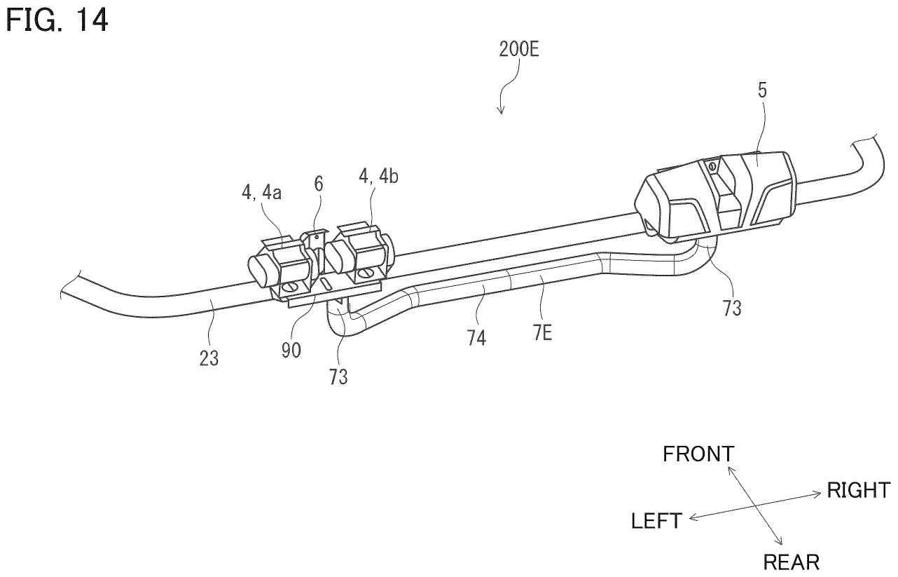

FIG. 14 is a perspective view of a cover attachment structure 200E according to a fifth variation when seen from the rear. The cover attachment structure 200E according to the fifth variation is different from the cover attachment structure 200D according to the fourth variation in a grip 7E. In the fifth variation, the same reference characters as those in the fourth variation denote the same components, and thus, description thereof will be omitted.

In the cover attachment structure 200E according to the fifth variation, the grip 7E includes end portions 73 located at both ends in the vehicle width directions and extending downward, and an intermediate portion 74 located between the end portions 73 at both ends and extending in the vehicle width directions. The intermediate portion 74 is located forward of the end portions 73 in the front-rear directions. The grip 7E is located below the hand bar 23.

In the thus-configured cover attachment structure 200E, since the intermediate portion 74 is located forward of the end portions 73 in the front-rear directions, in a case where one passenger grips the intermediate portion 74 and another passenger grips the end portions 73, the positions of the arms of the two passengers in the front-rear directions are different. This reduces interference between the arms of the two passengers.

The description of other configurations, operations, and effects will be omitted, but the description of the cover attachment structure 200D according to the fourth variation can be used for the description of the cover attachment structure 200E according to the fifth variation.

### «Other Embodiments»

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The numbers of the retractors 4, the covers 5, and the brackets 6 are not particularly limited, and may be increased or reduced. For example, the retractors 4 may be a pair of left and right retractors or may be one retractor.

Although the cover attachment structure 200 is located at each of the left and the right, the cover attachment structure 200 may be located at one of the left and the right.

Although the bracket 6 extends upward from the hand bar 23, the bracket 6 may extend in any one of downward, forward, or rearward.

Although the bracket 6 fixes the cover 5 at a position located above and away from the hand bar 23, the bracket 6 may fix the cover 5 at a position located below and away from the hand bar 23. Alternatively, the bracket 6 may fix the cover 5 at a position located either forward or rearward of the hand bar 23 and away from the hand bar 23.

Although the retractors 4 are attached to an upper portion of the hand bar 23, the retractors 4 may be attached to a lower portion of the hand bar 23.

The retractors 4 are attached to the hand bar 23, but may be attached to the bracket 6.

Although the cover 5 covers the retractors 4 from the rear, the cover 5 may cover the retractors 4 from above or from the rear, or may cover the retractors 4 from below or from the rear.

Although the bracket 6 includes the bracket-side fixing portion 65, the accessory attachment portions 66, and the stopper portion 67, at least one of the accessory attachment portions 66 or the stopper portion 67 may be omitted.

Although the cover 5 is fixed to the hand bar 23, the cover 5 may only contact the hand bar 23 without being fixed to the hand bar 23, and it is sufficient that displacement of the cover 5 is restricted by the hand bar 23.

The cover 5 and the hand bar 23 may be fixed by a fixing structure other than screws. For example, the cover 5 and the hand bar 23 may be fixed by a rivet, or a lock such as a nail may be partially employed. The cover 5 is preferably detachable from the hand bar 23 for maintenance of the retractors 4.

It is sufficient for the hand bar 23 to be located above the seat surfaces of the seats 17. For example, the hand bar 23 may be located at a position displaced from the shoulders of the seats 17 in the top-bottom directions.

The seats 17 may be bucket seats or bench seats. The seatbelts 3 may be 3-point seatbelts instead of 4-point seatbelts. In this case, one retractor 4 corresponds to one seat 17.

The support plates 40 or the bracket 6 may be fixed to the hand bar 23 without welding, for example, via a fastener such as a screw. The support plates 40 or the bracket 6 may be omitted with the retractors 4 or the covers 5 directly attached to the hand bar 23.

In the second and third variations, the intermediate portion 74 may be located rearward of the end portions 73 in the front-rear directions. Accordingly, in a case where one passenger grips the intermediate portion 74 and another passenger grips the end portions 73, the positions of the arms of the two passengers are different in the front-rear directions. This reduces interference between the arms of the two passengers.

In the second and third variations, the intermediate portion 74 may be located forward of the end portions 73 in the front-rear directions. Accordingly, in a case where one passenger grips the intermediate portion 74 and another passenger grips the end portions 73, the positions of the arms of the two passengers are different in the front-rear directions. This reduces interference between the arms of the two passengers.

In the second variation, the grip 7B may be attached to the bracket 6 such that the grip 7B is located below the hand bar 23. In the third variation, the grip 7C may be attached to the bracket 6 such that the grip 7C is located below the hand bar 23.

In the fourth variation, the grip 7D may be attached to the attachment plates 90 such that the grip 7D is located above the hand bar 23. In the fifth variation, the grip 7E may be attached to the bracket 6 such that the grip 7E is located above the hand bar 23.

The technique disclosed here is also applicable to an off-road vehicle other than the utility vehicle 100.

### [Aspects]

The embodiments described above are specific examples of the following aspects.

### (Aspect 1)

A cover attachment structure 200, 200A to 200E includes: a hand bar 23 located rearward of a seat 17 and extending in vehicle width directions; a retractor 4 that is attached to the hand bar 23 and retracts a seatbelt 3; a cover 5 covering the retractor 4 at least from rear; and a bracket 6 attached to the hand bar 23 and fixing the cover 5 at a position away from the hand bar 23 in a direction in which the hand bar 23 extends.

This configuration can prevent deformation of the cover 5 at a position away from the hand bar 23.

### (Aspect 2)

In the cover attachment structure 200, 200A to 200E, the bracket 6 includes a bracket-side fixing portion 65 that fixes the cover 5 at a side opposite to the hand bar 23 with respect to a center of the retractor 4.

In this configuration, the cover 5 can be fixed at a position away from the hand bar 23 while covering the retractor 4, thus further preventing deformation of the cover 5.

### (Aspect 3)

In the cover attachment structure 200, 200A to 200E of Aspect 1 or 2, the cover 5 includes a contact portion 51 in contact with the hand bar 23.

In this configuration, when the rear surface of the cover 5 is pushed forward, the contact portion 51 of the cover 5 comes into contact with the cover 5 so that the cover 5 can be supported by the hand bar 23.

### (Aspect 4)

In the cover attachment structure 200, 200A to 200E of any one of Aspects 1 to 3, the hand bar 23 includes a bar-side fixing portion 231 that fixes the cover 5 at a side opposite to the bracket-side fixing portion 65 with respect to a center of the retractor 4.

In this configuration, the retractor 4 is located between the bar-side fixing portion 231 and the bracket-side fixing portion 65, and thus, deformation of the cover 5 is easily prevented.

### (Aspect 5)

In the cover attachment structure 200, 200A to 200E of any one of Aspects 1 to 4, the hand bar 23 includes a bar-side fixing portion 231 that fixes the cover 5 to the bracket-side fixing portion 65 at positions on both sides that are spaced apart from each other in the vehicle width directions.

In this configuration, the cover 5 is fixed by the bracket-side fixing portion 65 of the bracket 6 and the two bar-side fixing portions 231 of the hand bar 23, and thus, deformation of the cover 5 is easily prevented.

### (Aspect 6)

In the cover attachment structure 200, 200A to 200E of any one of Aspects 1 to 5, the retractor 4 includes a first retractor 4a and a second retractor 4b arranged side by side in the vehicle width directions, and the bracket 6 is located between the first retractor 4a and the second retractor 4b.

In this configuration, both sides of the bracket 6 are covered by the first retractor 4a and the second retractor 4b, and thus, exposure of the bracket 6 is reduced.

### (Aspect 7)

In the cover attachment structure 200, 200A to 200E of any one of Aspects 1 to 6, the hand bar 23 includes a bar-side fixing portion 231 that fixes the cover 5 to the first retractor 4a and the second retractor 4b at positions on both sides that are spaced apart from each other in the vehicle width directions.

In this configuration, the cover 5 is fixed by the two bar-side fixing portions 231 of the hand bar 23, and thus, deformation of the cover 5 is easily prevented.

### (Aspect 8)

In the cover attachment structure 200, 200A to 200E of any one of Aspects 1 to 7, the cover 5 covers at least a portion of the bracket 6.

In this configuration, the cover 5 serves as both a component covering the retractor 4 and a component covering the bracket 6.

### (Aspect 9)

In the cover attachment structure 200, 200A to 200E of any one of Aspects 1 to 8, the cover 5 is open at front and covers the retractor 4 from rear, and a front surface of the retractor 4 is exposed to the front through a portion of the cover 5 where the cover 5 is open at the front.

This configuration can prevent interference between the seat 17 and the cover 5.

### (Aspect 10)

In the cover attachment structure 200, 200A to 200E of any one of Aspects 1 to 9, the cover 5 leaves a periphery of the bracket 6 exposed.

In this configuration, another member such as an accessory is easily attached to the bracket 6 through a region where the bracket 6 is exposed in a state where the cover 5 is attached.

### (Aspect 11)

In the cover attachment structure 200, 200A to 200E of any one of Aspects 1 to 10, the bracket 6 includes a stopper portion 67 that is in contact with the seat 17 and restricts rearward movement of the seat 17.

This configuration can restrict rearward movement of the seat 17.

### (Aspect 12)

In the cover attachment structure 200, 200A to 200E of any one of Aspects 1 to 11, the bracket 6 includes an accessory attachment portion 66 designed to attach an accessory different from the cover 5.

This configuration enables an accessory to be attached to the bracket 6.

### (Aspect 13)

The cover attachment structure 200, 200A to 200E of any one of Aspects 1 to 12 further includes a grip 7, 7A to 7E attached to the accessory attachment portion 66 of the bracket 6.

In this configuration, the bracket 6 enables attachment of the grip 7, 7A to 7E as well as the cover 5, and the bracket 6 serves as both a component supporting the cover 5 and a component supporting the grip 7, 7A to 7E.

### (Aspect 14)

A cover attachment structure 200, 200A to 200E includes: a hand bar 23 located rearward of a seat 17 and extending in vehicle width directions; a retractor 4 that is attached to an upper portion of the hand bar 23 and retracts a seatbelt 3; a bowl-shaped cover 5 that covers the retractor 4 from rear and leaves the retractor 4 exposed at front; and a bracket 6 attached to the hand bar 23 and fixing the cover 5 at a position above and away from the hand bar 23.

This configuration can prevent deformation of the cover 5 at a position away from the hand bar 23.

### (Aspect 15)

A utility vehicle 100 (off-road vehicle) includes: a seat 17; a seatbelt 3; a hand bar 23 located rearward of the seat 17 and extending in vehicle width directions; a retractor 4 that is attached to the hand bar 23 and retracts the seatbelt 3; a cover 5 covering the retractor 4 at least from rear; and a bracket 6 attached to the hand bar 23 and fixing the cover 5 at a position away from the hand bar 23 in a direction orthogonal to a direction in which the hand bar 23 extends.

This configuration can prevent deformation of the cover 5 at a position away from the hand bar 23.

What is claimed is:

1. A cover attachment structure comprising:
a hand bar located rearward of a seat and extending in vehicle width directions;
a retractor that is attached to the hand bar and retracts a seatbelt;
a cover covering the retractor at least from rear; and
a bracket attached to the hand bar and fixing the cover at a position away from the hand bar in a direction orthogonal to a direction in which the hand bar extends.

2. The cover attachment structure according to claim 1, wherein
the bracket includes a bracket-side fixing portion that fixes the cover at a side opposite to the hand bar with respect to a center of the retractor.

3. The cover attachment structure according to claim 1, wherein
the cover includes a contact portion in contact with the hand bar from rear.

4. The cover attachment structure according to claim 2, wherein
the hand bar includes a bar-side fixing portion that fixes the cover at a side opposite to the bracket-side fixing portion with respect to a center of the retractor.

5. The cover attachment structure according to claim 2, wherein
the hand bar includes a bar-side fixing portion that fixes the cover to the bracket-side fixing portion at positions on both sides that are spaced apart from each other in the vehicle width directions.

6. The cover attachment structure according to claim 1, wherein
the retractor includes a first retractor and a second retractor arranged side by side in the vehicle width directions, and
the bracket is located between the first retractor and the second retractor.

7. The cover attachment structure according to claim 6, wherein
the hand bar includes a bar-side fixing portion that fixes the cover to the first retractor and the second retractor at positions on both sides that are spaced apart from each other in the vehicle width directions.

8. The cover attachment structure according to claim 1, wherein
the cover covers at least a portion of the bracket.

9. The cover attachment structure according to claim 1, wherein
the cover is open at front and covers the retractor from rear, and
a front surface of the retractor is exposed to the front through a portion of the cover where the cover is open at the front.

10. The cover attachment structure according to claim 1, wherein
the cover leaves a periphery of the bracket exposed.

11. The cover attachment structure according to claim 1, wherein
the bracket includes a stopper portion that is in contact with the seat and restricts rearward movement of the seat.

12. The cover attachment structure according to claim 1, wherein
the bracket includes an accessory attachment portion designed to attach an accessory different from the cover.

13. The cover attachment structure according to claim 12, further comprising
a grip attached to the accessory attachment portion of the bracket.

14. A cover attachment structure comprising:
a hand bar located rearward of a seat and extending in vehicle width directions;
a retractor that is attached to an upper portion of the hand bar and retracts a seatbelt;
a bowl-shaped cover that covers the retractor from rear and leaves the retractor exposed at front; and
a bracket attached to the hand bar and fixing the cover at a position above and away from the hand bar.

15. An off-road vehicle comprising:
a seat;
a seatbelt;
a hand bar located rearward of the seat and extending in vehicle width directions;
a retractor that is attached to the hand bar and retracts the seatbelt;
a cover covering the retractor at least from rear; and
a bracket attached to the hand bar and fixing the cover at a position away from the hand bar in a direction orthogonal to a direction in which the hand bar extends.
